(19) United States
(12) Patent Application Publication
(10) Pub. No.: US 2023/0199041 A1
(43) Pub. Date: Jun. 22, 2023

(54) REMOTE COLLABORATION PLATFORM

(71) Applicant: NEVOLANE BUSINESS GMBH, Rorschach (CH)

(72) Inventors: Christian SCHORR, Tübach (CH); Nicholas INGULFSEN, Rorschach (CH); Jonas KLUCKERT, Tübach (CH); Christian SCHMID, Bronschhofen (CH)

(73) Assignee: NEVOLANE BUSINESS GMBH, Rorschach (CH)

(21) Appl. No.: 17/558,156

(22) Filed: Dec. 21, 2021

(51) Int. Cl. H04L 65/403; H04L 65/401; G06T 7/70; H04L 65/1093; G06F 3/04817

(52) U.S. Cl. CPC H04L 65/403; H04L 65/4015; G06T 7/70; H04L 65/1093; G06F 3/04817

(57) ABSTRACT

Computer-implemented method for providing a virtual collaboration environment for a plurality of users, each user being associated with one of a plurality of client devices that are connected via a data network, the method comprising capturing live images of each of the plurality of users, visualizing a GUI on a display of each of the client devices, displaying, within each GUI, live images of at least a subset of the plurality of users, receiving a first user input from any user of the subset requesting audio communication with any other user of the subset, starting a first communication session between a first client device associated with the requesting user and a second client device associated with the other user, automatically enabling mutual audio communication between the first client device and the second client device, and displaying, within each GUI, a first graphical indicator of the ongoing first communication session and the users involved in the ongoing first communication session.

### BACKGROUND

Tools for online collaboration and communication have found a wide acceptance and distribution amongst individuals and organisations in private and business environments. With people working from home, or from different offices, video conference systems often became a standard to keep in touch.

Beside the augmented possibilities using streaming camera images and screen-share, a video conference is basically a remote meeting, comparable with a telephone call or a conference call, by intention. Thus, the workflow is kind-of traditional to a call, which means that video conference calls often need to be scheduled or announced. If someone tries to start a call spontaneously there is a risk that the addressed person is absent or feels disturbed by a call at the wrong time—often turning down the good intention of the communication attempt. At least in some instances, e.g., if a company is using a common collaboration tool synchronized with the calendar function, it might give an indication via a status that is however only as reliable as people feed their calendar and check that their status is displayed properly.

Spontaneous communication naturally takes place when people sit next to each other. If few people share the same office, they typically know the status of their colleagues well, and spontaneous communication happens in a natural way.

Some managers fancy open-plan offices because they assume that this makes communication happen more often and thus makes team work more efficient. However, during current pandemic situation is a no-go for having many people sitting in the same room.

Known tools for remote communication require communication before actually communicating about the topic. One must chat before talking, or ring somebody, or stand up and move to the room next door.

Thus, it would be desirable to have a more efficient collaboration between a plurality of users working remotely from each other, e.g. from home.

### SUMMARY

The present invention pertains to a method for remote communication platform connecting a plurality of collaborating participants. More particularly, an application is proposed that can run on any mobile device or computer and establish a permanent video stream amongst the participants without audio turned on. This simulates to the users that they are sitting next to someone, e.g., by having the camera looking at a user from the side like if colleagues will look at each other if they share an office. As the users can watch others at their work, they know when there is a good moment to start talking with them by activating the audio connection on both ends.

It is therefore an object of the present invention to provide an improved method and system for providing a virtual collaboration environment for a plurality of users.

It is another object of the invention, to provide such a method and system that allows a more efficient remote collaboration between the users.

It is a further object to provide such a method and system that allows initiating remote discussions faster and more easily, particularly without the need for invitations or scheduling.

It is a further object to provide such a method and system that allows the users to have sight to each other already before the talk starts and to get immediate visual and spoken feedback whether a discussion is appropriate at this time.

It is a further object to provide such a method and system that allows initiating remote discussions that do not disturb the other users.

At least one of these objects is achieved by the claimed computer-implemented methods the claimed system, or the dependent claims of the present invention.

A first aspect of the invention pertains to a computer-implemented method for providing a virtual collaboration environment for a plurality of users, each user being associated with one of a plurality of client devices that are connected via a data network. The method comprises capturing live images of each of the plurality of users, visualizing a graphical user interface (GUI) on a display of each of the client devices, and displaying, within each GUI, live images of at least a subset of the plurality of users. According to this aspect of the invention, the method further comprises
receiving a first user input from any user of the subset requesting audio communication with any other user of the subset;
starting, automatically and based on the first user input, a first communication session between a first client device associated with the requesting user and a second client device associated with the other user, wherein starting the first communication session comprises automatically enabling mutual audio communication between the first client device and the second client device; and
displaying, within each GUI, a first graphical indicator of the ongoing first communication session and the users involved in the ongoing first communication session.

According to some embodiments, the method—while the first communication session is ongoing—comprises:
receiving a second user input from any user of the subset not involved in the first communication session requesting audio communication with any other user of the subset not involved in the first communication session;
starting, automatically and based on the second user input, a second communication session between a third client device associated with the requesting user and a fourth client device associated with the other user (i.e. the requesting user and other user not involved in the first communication session), wherein starting the second communication session comprises automatically enabling mutual audio communication between the third client device and the fourth client device; and
displaying, within each GUI, a second graphical indicator of the ongoing second communication session and the users involved in the ongoing second communication session (i.e. additionally to the first graphical indicator).

According to some embodiments of the method, an input option is provided within in each graphical user interface, the input option allowing each user of the subset requesting audio communication with the other users of the subset, wherein the first user input (and optionally the second user input) comprises a selection of said input option.

According to some embodiments of the method, starting a communication session (i.e. at least the first communication session) does not involve any interaction from the other user and/or comprises automatically activating a speaker and a microphone of the client device of the other user.

According to some embodiments, the method comprises determining an absence of a user of the subset from the environment and a return of the user to the environment (i.e. none of the users involved in an ongoing communication session), for instance wherein no communication session with the client device associated with the absent user can be requested or opened during the user's absence. According to these embodiments, the method comprises:
displaying, during the absence, a graphical indicator of the user's absence within each GUI, e.g. instead of the live image of the absent user; and
stopping, during the absence, displaying the live images of other users within the graphical user interface of the absent user.

Determining the absence may comprise:
receiving a user input from the user indicating an absence from the environment, such as a break;
determining that the user has turned off a camera capturing the live image of the user; and/or
using image recognition for determining that the user is absent or not recognizable in the live image.

Determining the return may comprise:
receiving a user input from the user indicating a return to the environment, such as an end of a break;
determining that the user has turned on the camera again; and/or
using image recognition for determining that the user is present and recognizable in the live image.

According to some embodiments of the method, displaying the live images comprises displaying image elements in a container of the GUI, one live image being displayed within each of the image elements. In one embodiment, the image elements are displayed as bubbles, i.e. having a circular shape.

In some embodiments, displaying the graphical indicator of the ongoing communication session comprises a grouping of the image elements that display the live images of the users involved in the ongoing communication session. For instance the graphical indicator may comprise a same colouring of a border of each of the grouped elements, a ring-shaped element encircling the grouped elements, and/or lines connecting the grouped elements.

In some embodiments, displaying the image elements comprises placing the image elements in the container using a physics simulation, the physics simulation comprising each image element being influenced by every other image element through a force. Said force is attractive if the users of the respective live images are involved in an ongoing mutual communication session, is repulsive if the users of the respective live images are not involved in an ongoing mutual communication session, and is the stronger, the closer the image elements are to each other.

In some embodiments, the physics simulation comprises the image elements colliding with each other and with a border of the container.

In some embodiments, the physics simulation is performed locally on the client devices, so that every user may have the image elements placed in the container individually.

In some embodiments, the physics simulation recalculates the position of each image element when a user joins or leaves the virtual collaboration environment, when a communication session is opened or closed, and when a user joins or leaves a communication session.

In some embodiments, the recalculation is iterated over a defined number of time steps and comprises calculating an influence of the summed force of all other image elements on each image element.

If the position of each image element position has been recalculated, in some embodiments an animation is performed in real time, the animation showing a movement of one or more image elements to their recalculated position.

In some embodiments, a size of the image elements depends on
a size of the screen and/or of the container,
a number of image elements on the screen and/or in the container, and
a status of the user of the live image displayed within the respective image element, the status at least comprising being involved in an ongoing communication session or not.

For instance, an image element or the live image displayed therein (or both) may be enlarged if the image element displays a live image of a user being involved in an ongoing communication session with the user of the client device on the display of which the GUI is displayed.

According to some embodiments of the method, the plurality of users joins the environment upon an invitation of an administrator of the environment.

According to some embodiments of the method, each of the client devices comprises a user interface, a memory, a processor, a network interface, a camera, a speaker and a microphone, wherein
the user interface provides the GUI and receives user inputs,
the camera captures the live image of the user, and
the speaker and the microphone are used in the communication session.

A second aspect of the invention pertains to a computer-implemented method for providing a virtual collaboration environment for a plurality of users, each user being associated with one of a plurality of client devices that are connected via a data network, wherein each of the client devices comprises a user interface, a memory, a processor, a network interface, a camera, a speaker and a microphone. According to this aspect of the invention, the method comprises
capturing live images of each of the plurality of users using the cameras;
visualizing a graphical user interface on a display of each of the client devices; and
displaying, within each graphical user interface, live images of at least a subset of the plurality of users;
providing, within each graphical user interface, an input option for requesting an audio communication with the other users of the subset;
receiving, on any one of the user interfaces, a first user input from a user of the subset requesting audio communication with another user of the subset;
starting, based on the first user input, a first communication session between a first client device associated with the requesting user and a second client device associated with the other user, wherein starting the first communication session comprises enabling mutual audio communication between the first client device and the second client device using the speakers and the microphones of the first client device and the second client device;
displaying, within each graphical user interface, a first graphical indicator of the ongoing first communication session and the users involved in the ongoing first communication session.

A third aspect of the invention pertains to a system for providing a virtual collaboration environment for a plurality of users, the system comprising a plurality of client devices that are connected via a data network, each user being associated with one of the client devices, each of the client devices comprising a user interface, a memory, a processor, a network interface, a camera, a speaker and a microphone, a client communication application being stored in the memory and executable by the processor, the system being configured for performing the method according to the first aspect of the invention.

According to some embodiments, the system comprises a server computer that is connected with the client devices via the data network, the server computer comprising a server memory, a server processor and a server network interface, a communication manager application being stored in the server memory and executable by the server processor, the communication manager application being configured to serve requests from the client communication applications of the client devices.

A fourth aspect of the invention pertains to a computer programme product comprising programme code which is stored on a machine-readable medium, or being embodied by an electromagnetic wave comprising a programme code segment, and having computer-executable instructions for performing the method according to the first aspect of the invention.

### BRIEF DESCRIPTION OF THE DRAWINGS

The invention in the following will be described in detail by referring to exemplary embodiments that are accompanied by figures, in which:

FIG. 1 illustrates an exemplary embodiment of a system according to the invention;

FIG. 2 illustrates an exemplary embodiment of a method according to the invention;

FIG. 3 illustrates an exemplary embodiment of a graphical user interface on a screen of a user of a computer programme product according to the invention;

FIGS. 4a-b illustrate joining a communication using the graphical user interface;

FIGS. 5a-c illustrate initiating a communication using the graphical user interface; and

FIGS. 6a-b illustrate changing between two spaces in the graphical user interface.

### DETAILED DESCRIPTION

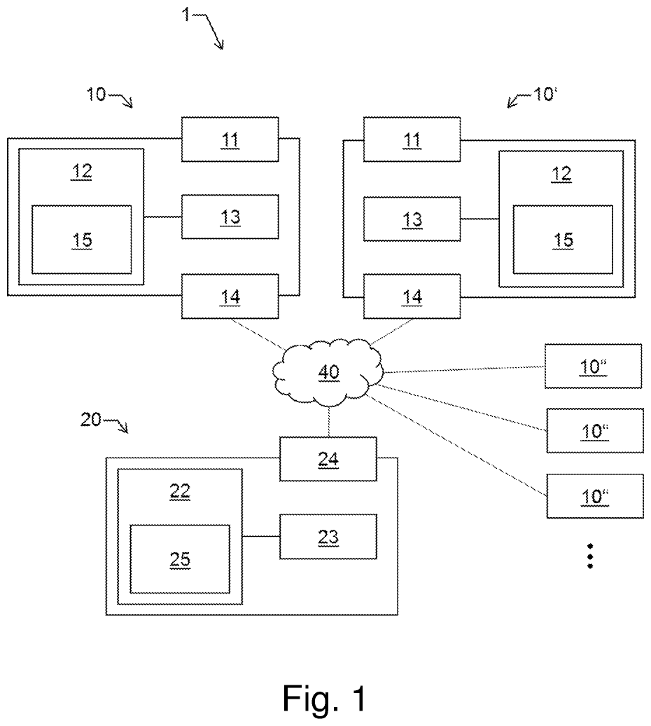

FIG. 1 is a diagram showing an exemplary embodiment of a client/server system 1 according to the invention, which allows multiple users to communicate. According to the shown example, the client/server system includes a server device 20 and a number of client devices 10, 10′, 10″, each client device being associated with a particular user. The client devices 10, 10′, 10″ for instance may be embodied as desktop computers, laptop computers, smartphone devices, and/or tablet devices. The system 1 comprises at least two client devices, including a first client device 10 and a second client device 10′, which are illustrated here in detail. Optionally, the system comprises a multitude of further client devices 10″.

The server 20 may comprise any appropriate hardware such as, for instance, a multi-processor general-purpose computer running an operating system. The server 20 runs a communication manager application (CMA) 25 that serves requests from a client communication application (CCA) 15 running on each of the client devices 10, 10′, 10″.

Each client device 10, 10′, 10″ includes a user interface 11, a memory 12 including software, a processor 13 for executing the software and a network interface 14 for connecting the client device with the server 20 and other devices via a network 40, e.g. the Internet, a local area network or a cellular network. The software may include an operating system, the CCA 15 and various other software applications. The user interface 11 may include a number of input devices such as a mouse, touchpad or touchscreen that allow respective the user to interact with the client device via a graphical user interface (GUI) on a display. Each client device 10, 10′, 10″ additionally comprises a camera 16 to capture images of the user, particularly an image stream, a microphone 17 and speakers 18, e.g. a loudspeaker or headphones.

The server 20 includes a memory 22 and a processor 23. The memory has stored thereon the CMA 25. The server 20 also comprises a network interface 24 for communicating with other devices such as the client devices 10, 10′, 10″ over the network 40.

The CMA 25 manages communication sessions involving one or more types of media and between one or more client devices 10, 10′, 10″. The users of these devices may have an account registered with the CMA 25 and access said account through any device having the CCA 15 installed thereon. When a user logs in using the CCA 15 of a specific device, the CMA 25 can register that device with a unique identification number for that user. Thus, when another user attempts to start a multimedia communication with that user, the packet stream will be directed to the proper device.

The CCA 15 can run on any mobile device or computer. As described below, it is configured to establish permanent video streams amongst the participants. In order to provide the possibility of low-threshold communication between two or more of the plurality of users, the CCA 15 allows any user to turn on an audio channel with any other user.

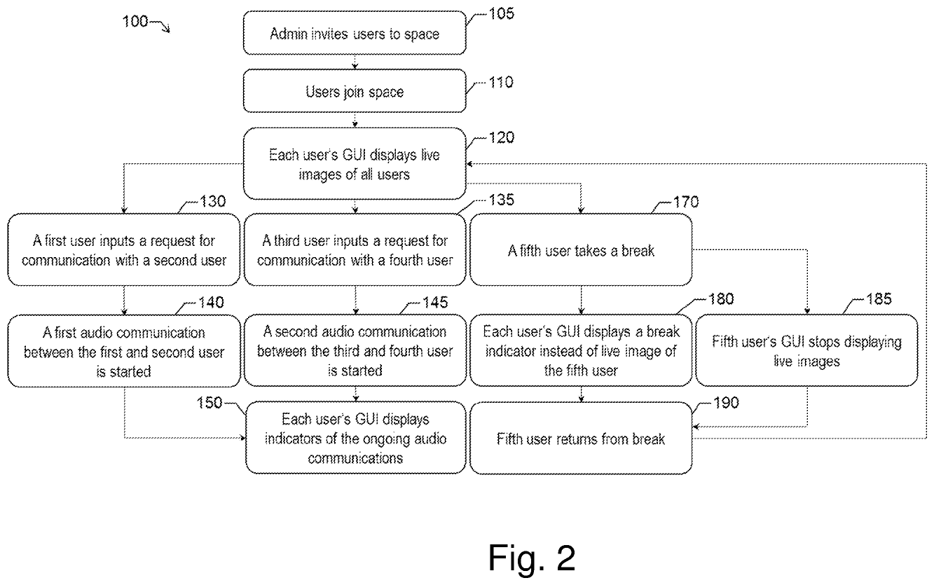

FIG. 2 is a flow chart illustrating an exemplary embodiment of a method 100 according to the invention. The method starts with step 105, in which an administrator (admin) invites registered users to join 110 a collaboration environment or “space”. This space is an entity that users can join and leave; all users of a space can enter the space and hence participate in the space's conference. Registration allows the users to identify themselves with a unique identity. With their unique identity each user can join spaces by invitation, or they start a new space—thus becoming admin of that space
and invite other users to join. The members can leave the space anytime or be removed from a space by the space owner or administrator. Optionally, the users may be recognized automatically by a live image taken by a camera of their device.

Administered spaces may be established for a distinct team or a company. The users having joined 110 such a consistent space can be referred to as members of a “crew”. Each crew can have its own space or spaces to which only the crew members have access to, i.e. upon being invited 105 by the admin. However, spaces can also be established spontaneously by any user, e.g. for a temporary or short-term project.

When entering a space, each user is presented a graphical representation of that space on a graphical user interface (GUI). This graphical representation includes displaying live images (e.g. a video stream) of all users that have joined the same space (step 120). Thus, per default, everybody can see each other without hearing them. Optionally, the users can also see their own video.

Preferably, as a golden rule, only users who can be seen by the others, can see the others as well. If someone cannot be seen in the live images, this can be noticed by the software and the live images of the other users are not shown in the GUI of that user.

If a user wants to start a communication with another user, he enters a request by an input in the GUI (step 130), e.g. by clicking or tapping on the live image of said user. This directly opens 140 an audio communication between these users without the need to accept the call. Optionally, a sound might indicate to the involved users that the audio channel has been opened.

During the communication, each users' GUI displays 150 an indicator of the ongoing audio communication and its participants. Thus, all users of the space are informed that two users are currently communicating. The indicator may be a symbol that appears on screen indicating that both people have an audio connection active. Alternatively or additionally, the live images may automatically be rearranged in the GUI.

While the communication goes on, other users might join the communication or start another communication. For instance, a third user wants to start a communication with another (fourth) user and enters a respective request by an input in the GUI (step 135), which opens 145 a parallel audio communication between the third and fourth user. Also this communication is indicated to the other users in the GUI (step 150).

If two people are talking, they can add anyone else to the discussion, e.g. by clicking or tapping on the respective user's live image. Likewise, if someone wants to join an ongoing discussion, he might simply click or tap on the running discussion to open an audio channel. Optionally, the others are getting noticed by a sound signal that somebody joined the ongoing conversation.

If confidentiality is desired, the users can mark their communication as such, so that others cannot join unless being added to the communication by one of the participants. Optionally, only the users talking to each other see themselves, i.e. they do not see the others and the others do not see them.

The users may take breaks without having to leave the space. In the exemplary embodiment of the method 100 shown in FIG. 2, a user wants to take a break and performs a corresponding user input 170, e.g. by clicking or tapping on a symbol in the GUI. This break effects displaying 180, in each of the other users' GUI a break indicator instead of the live image of the user taking the break. At the same time, the GUI of the user taking the break stops displaying the live images of the other users (step 185). When the user signals return from the break (step 190), the displaying 120 of the live images is resumed.

Different pause modes may be available that optionally effect displaying different break indicators on the other users' GUIs. For instance, an AFK mode (AFK=away from keyboard) may indicate that a user is busy but will be back soon. Having the programme (app) running in the background may equal AFK mode. A coffee or lunch break mode may automatically after a defined time span minutes (e.g. configurable from 2 up to 30 minutes). In this mode, a remaining time may be displayed by a clock running backwards. A stop mode might indicate that the user is done for the day. Closing the app might equal the stop mode. An absence of the user in the images may be automatically detected and interpreted as a break. The same may apply if he image is too dark to recognize the user or if the camera is switched off.

User can be members of more than one crew and join more than one space at the same time. The GUI of a user who is in multiple spaces in parallel, may display the multiple conferences next to each other on the user's screen, certainly within the restriction of a meaningful size of images being able to be displayed. A user who is in a communication in a first space, may be switched to AFK mode for all other spaces for the time the communication goes on in the first space.

In traditional video conferencing, control over the system is hierarchical:
an admin invites participants (clients);
the admin can block usage of camera and microphone for clients;
the admin has no influence about the individual loudspeaker settings;
the admin otherwise has all rights of a client as well;
the clients can turn their own camera on/off (unless “on” is blocked by admin)
the clients can mute/unmute their own microphone (unless “unmute” is blocked by admin)
the clients can mute/unmute others (unless “unmute” is blocked by admin)
the clients have full access over their system loudspeaker (including to turn it off completely) but not about other clients' loudspeakers.

This is different in the method and system according to the present invention, wherein:
the admin invites the participants, but otherwise has no function and is equal to the other participants in using the space;
the clients can turn their own camera on/off (e.g. when in a break), also indicating to other people not being accessible for that period;
the clients can open audio (i.e. microphone and loudspeaker) for any bi-lateral or multilateral communication with anyone in the space (unless the participant declines or is temporarily not accessible).

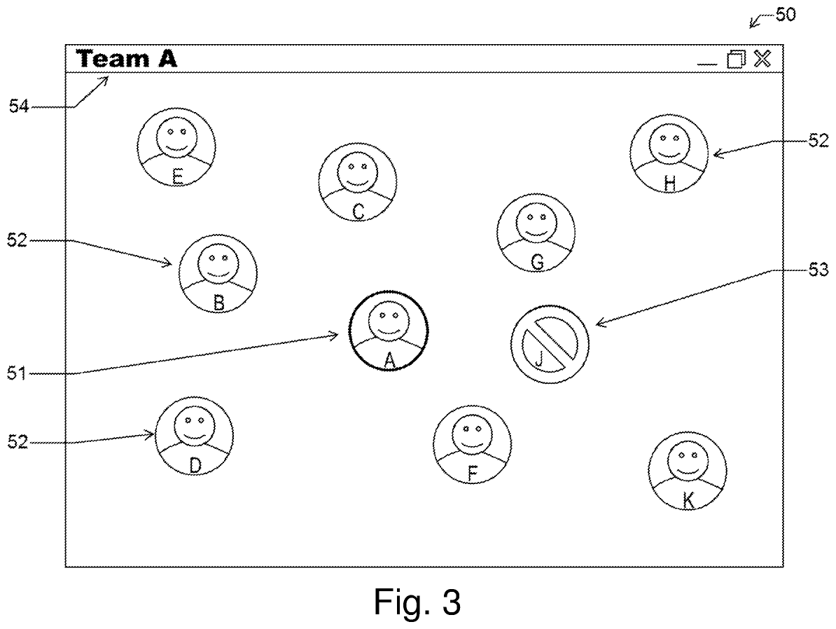

FIGS. 3 to 10 show examples of a GUI 50 displayed on a screen of a client device of a first user, illustrating the functions of illustrative embodiments of a method and software according to the invention. In the shown example, the user is a member of a crew named “Team A”.

FIG. 3 shows the GUI 50 comprising a window on a screen, the window showing the title 54 of the crew “Team A”. Below the title bar, the space is shown with elements showing live images 51, 52 of all users that are present in the space (image elements). As shown here, the live image 51 of the first user may be marked, e.g. highlighted or surrounded by a differently coloured frame. Preferably, the live images are accompanied by a numerical identifier of the respective user, e.g. a name or chosen nick name of the user. In the shown example, the name of the first user is “A”, and the other members of the team that are present in the space are named “B”, “C”, “D”, “E”, “F”, “G”, “H” and “K”.

User “J” is a member of the team but currently on a break, so that a symbol 53 is shown that indicates the break instead of a live image of “J”. The symbol may comprise a pictogram and/or text, e.g. an image of a cup of coffee, a text like “AFK” or a picture of the user. Alternatively, the indicator symbol 53 may be displayed together with the live image of “J”, wherein the live image is displayed without colour, with less contrast and/or obscured.

The other users are present, so that their live images 52 are shown in the GUI 50. The permanent video streams amongst the participants simulates to the users that they are sitting next to each other, e.g., by having the camera looking at a user from the side like if colleagues will look at each other if they share an office. As the users can watch each other at their work, they know when there is a good moment to start talking with them.

As illustrated here, all live images 51, 52 may be shown in elements that are shaped like circles or “bubbles” and be placed freely on the screen based on a physics model. Other shapes are also possible, e.g. square or polyhedral elements. Optionally, the size of the image elements and the live images scales not only depending on the number of participants and the screen size, but also individually based on a user's status (e.g. active or on a break) and on whether a user is in a communication or not.

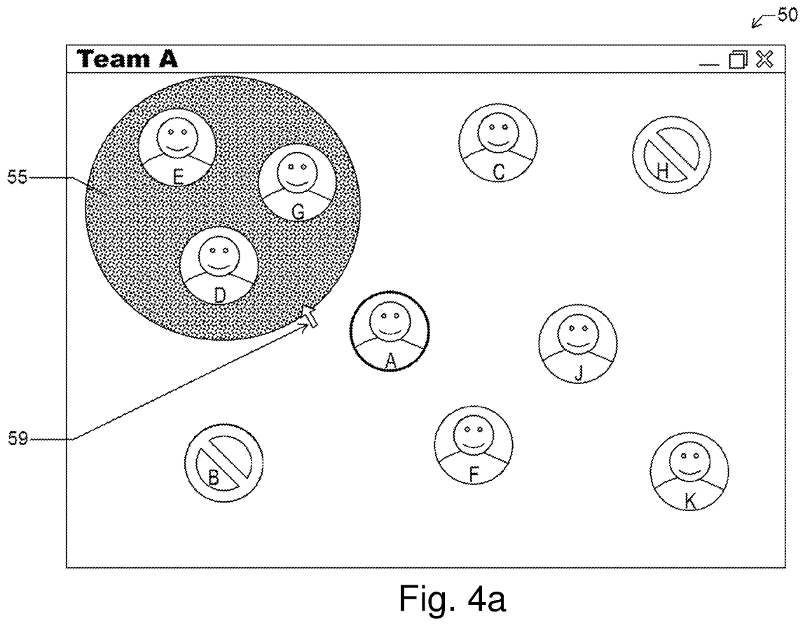

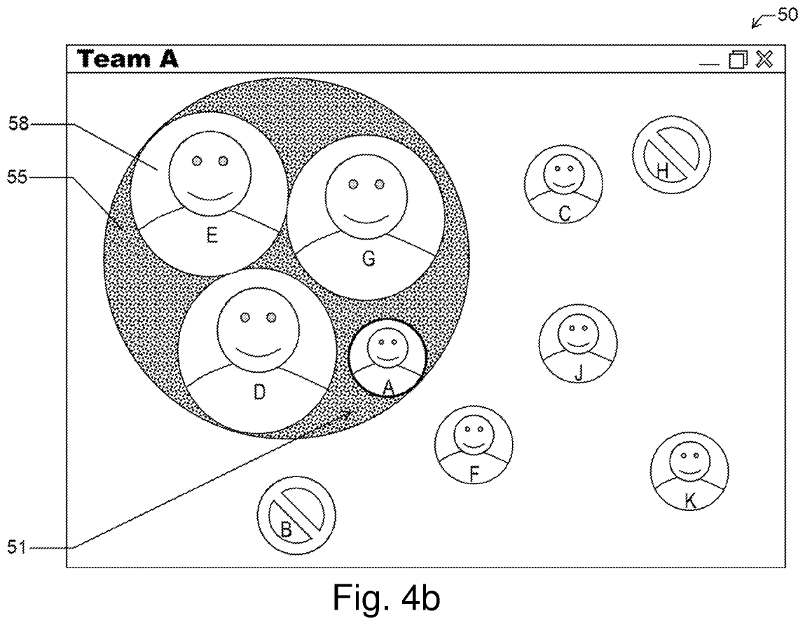

In FIGS. 4a-b, a situation is illustrated, in which the three users “D”, “E” and “G” are engaged in a conversation. In FIG. 4a, this is indicated on the first user's GUI 50 by grouping the live images 52 of these three users together and drawing a circle 55 around them. The regrouping of the three live images 52 may also affect the positions of other live images that need to be moved away from the newly formed circle 55. Alternatively, communications may be indicated differently. For instance, live images of users in a communication may be placed next to each other and their bubbles' border may be coloured.

If the first user “A” chooses to join the conversation between “D”, “E” and “G”, he moves the cursor 59 to the circle 55 and inputs his wish to join the conversation by clicking on the circle 55. Of course, the same is possible with other input means, e.g. by tapping on a touchscreen. The result is shown in FIG. 4b, where the live images of “D”, “E” and “G” and the live image 51 of “A” have been regrouped, so that the live image 51 of “A” is now inside of the circle. Since the first user is in a communication with “D”, “E” and “G”, the live images of these users may be shown as enlarged live images 58, to allow the first user to better see the people he communicates with.

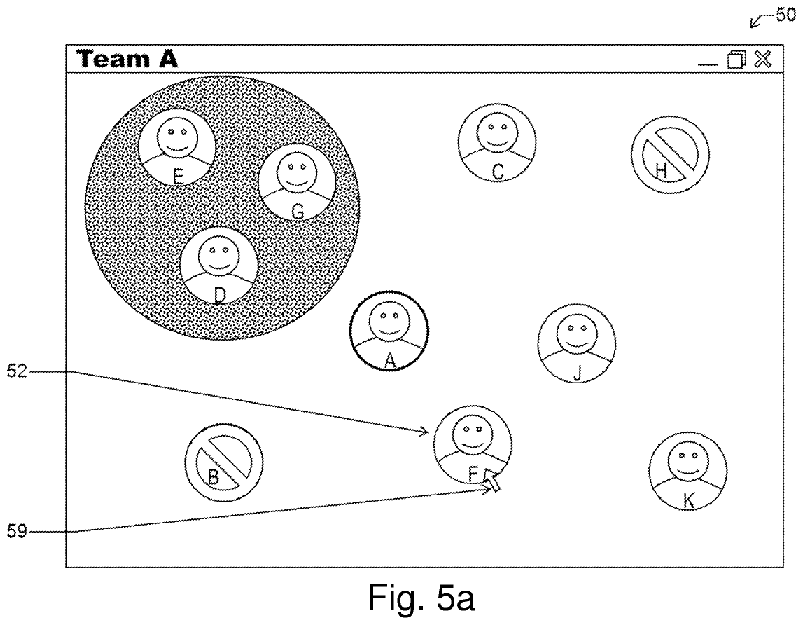

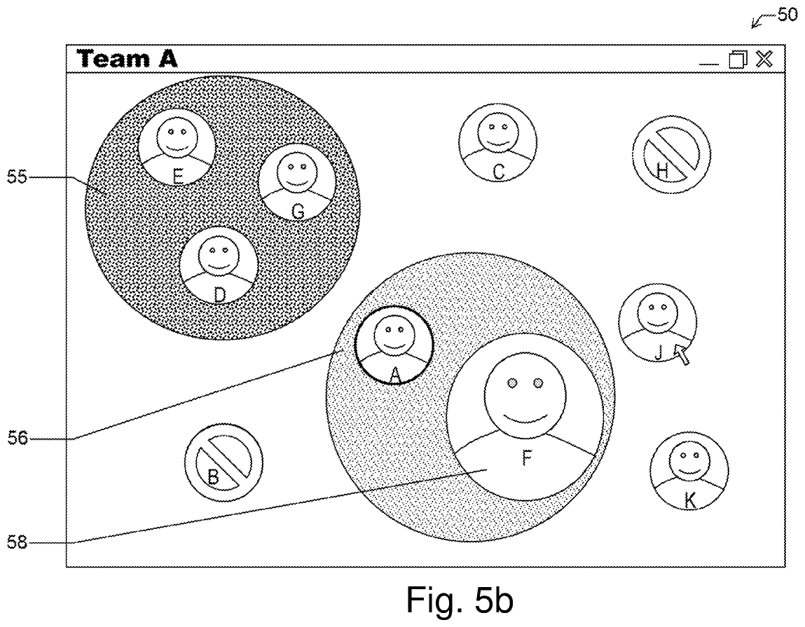

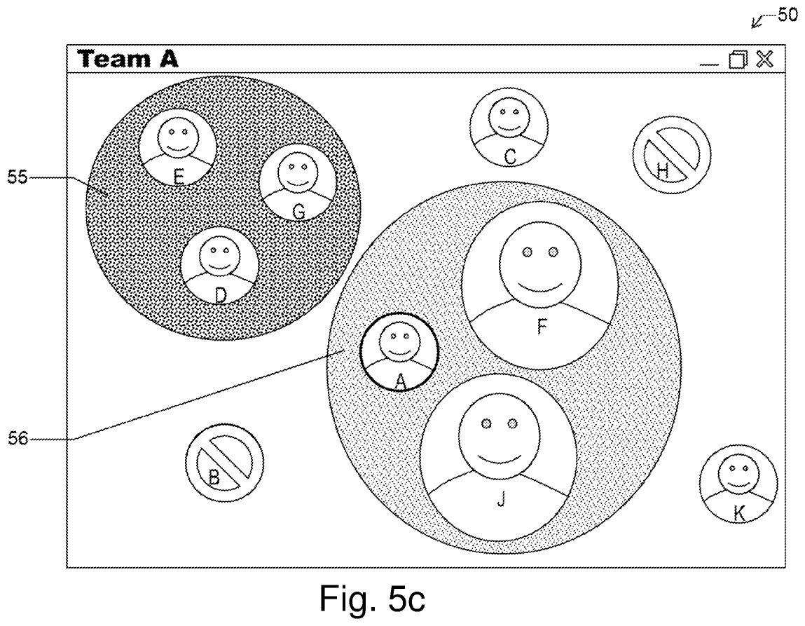

FIGS. 5a-c illustrate a situation, in which the first user “A” wants to engage in a communication with the other users “F” and “J”. In FIG. 5a, the first user moves the cursor 59 to the live image 52 of user “F” and clicks on the image 52 to open the audio channel. In FIG. 5b, this is indicated on the GUI 50 by grouping the live images 51, 52 of these two users together and drawing a circle 56 around them. Also, the live image of user “F” is now enlarged 58. The first user the moves the cursor 59 to the live image 52 of user “J” and clicks (or taps on a touchscreen) on the image 52 to add “J” to the conversation, thus opening an audio channel with “J”. The result is shown in FIG. 5c, where the live images of “A”, “F” and “J” have been regrouped, so that also the enlarged live image of “J” is now inside of the circle 56.

The image elements with the live images 51, 52 may be placed freely on the screen based on a physics simulation model. For instance, this physics simulation may work as follows:
each image element is influenced by every other element through a force, wherein this force is attractive when users are in a communication, and repulsive, if not, and wherein force is the stronger the closer the elements are to each other;
the elements collide with each other and with the (invisible) border of a container, which holds all the elements on the screen;
the elements may merge with each other if the users are in a communication (e.g. in the case of round elements, two merged elements together would form an 8);
the position of each element needs to be recalculated on every rearrangement through running the simulation, e.g. when a user joins or leaves the conference or joins or leaves a communication;
for every rearrangement, the algorithm iterates over a defined number of time steps (“ticks”) and calculates the influence of the summed force of all other elements on each individual element;
after the new position of every element has been calculated, an animation of the movement to this new position is performed for each element.

These steps may be performed in real time and optimized to be performed in such a small time that the user generally experiences the resulting animation as immediate.

The simulation may be performed locally, so that every user has his/her individual conference interface. Since users that have a communication are moved next to each other, users that have a lot of communications together may be organically placed closer to each other.

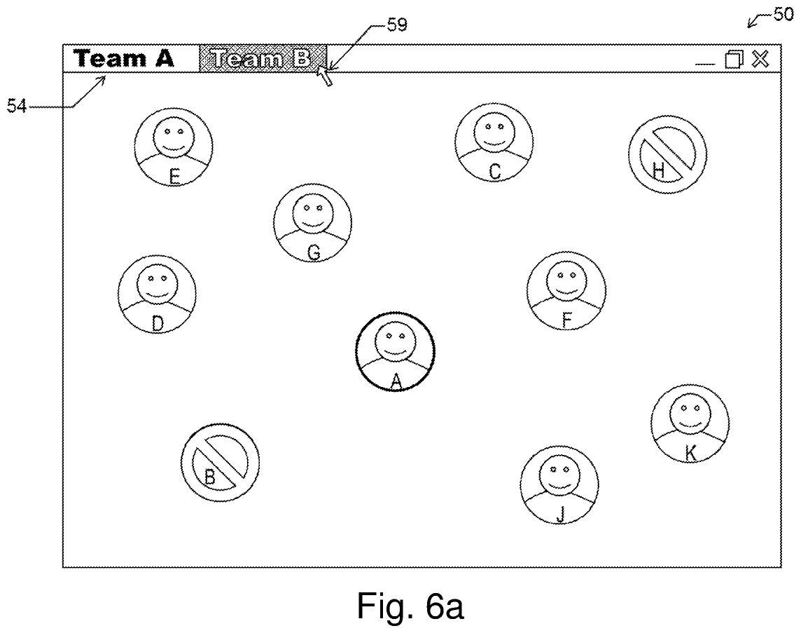

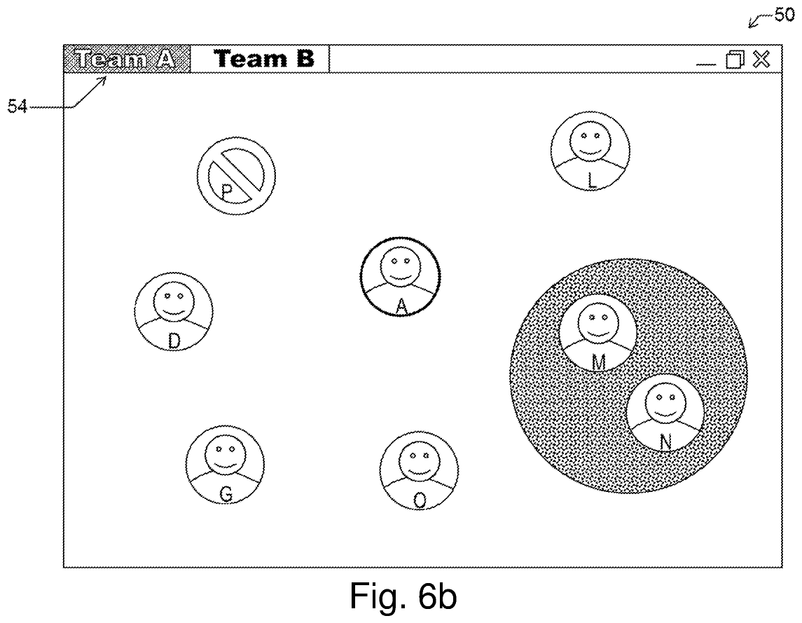

FIGS. 6a-b illustrate the change between a first space and a second space for the first user who is member of both groups. For instance, the same user may be logged in with two accounts (e.g. one work account and one private account), or be a member of two crews working on different projects and thus having different spaces.

FIG. 6a shows the GUI 50 of the first user “A” while being in the space of “Team A”. Since the first user is member of two spaces, the title bar 54 shows the names of the two spaces “Team A” and “Team B”, whereas “Team A” is highlighted. If the first user wants to change to the second space, he moves the cursor 59 to the title bar 54 and clicks on “Team B”. The result of this selection is shown in FIG. 6b. The GUI 50 now shows the space of “Team B” with the live images of the first user “A” and of the other users that are members of the crew of “Team B”, i.e. users “D” and “G” who, like the first user are members of both “Team A” and “Team B”, and the users “L”, “M”, “N” and “O”. Since Member “P” is taking a break, his live image is not shown. Since members “M” and “N” are currently engaged in a conversation, this is indicated on the GUI 50 as well. Alternatively, e.g. if the screen size allows, the two spaces of “Team A” and “Team B” might be displayed next to each other of the same screen. If the device of the first user comprises more than one screen, the spaces might be displayed of different screens.

If the user is involved in a conversation in one space, this status might automatically be indicated in the other spaces, i.e. a symbol might be displayed instead of the user's live image indicating that the user is busy or absent. Optionally, the user might add users from other spaces to the ongoing conversation.

Although the invention is illustrated above, partly with reference to some preferred embodiments, it must be understood that numerous modifications and combinations of different features of the embodiments can be made. All of these modifications lie within the scope of the appended claims.

What is claimed is:

1. A computer-implemented method for providing a virtual collaboration environment for a plurality of users, each user being associated with one of a plurality of client devices that are connected via a data network, the method comprising:
capturing live images of each of the plurality of users;
visualizing a graphical user interface on a display of each of the client devices; and
displaying, within each graphical user interface, live images of at least a subset of the plurality of users;
receiving a first user input from any user of the subset requesting audio communication with another user of the subset;
starting, based on the first user input, a first communication session between a first client device associated with the requesting user and a second client device associated with the other user, wherein starting the first communication session comprises enabling mutual audio communication between the first client device and the second client device;
displaying, within each graphical user interface, a first graphical indicator of the ongoing first communication session and the users involved in the ongoing first communication session.

2. The method according to claim 1, wherein within in each graphical user interface, an input option is provided for requesting audio communication with the other users of the subset, and the first user input comprises a selection of the input option.

3. The method according to claim 1, comprising, while the first communication session is ongoing,
receiving a second user input from any user of the subset not involved in the first communication session requesting audio communication with any other user of the subset not involved in the first communication session;
starting, based on the second user input, a second communication session between a third client device associated with the requesting user and a fourth client device associated with the other user, wherein starting the second communication session comprises enabling mutual audio communication between the third client device and the fourth client device; and
displaying, within each graphical user interface, a second graphical indicator of the ongoing second communication session and the users involved in the ongoing second communication session.

4. The method according to claim 1, wherein starting a communication session
comprises automatically activating a speaker and a microphone of the client device of the other user, and/or
does not involve any interaction from the other user.

5. The method according to claim 1, comprising determining an absence of a user of the subset from the environment and a return of the user to the environment, the method comprising:
displaying, during the absence, a graphical indicator of the user's absence within each graphical user interface; and
stopping, during the absence, displaying the live images of other users within the graphical user interface of the absent user,
wherein determining the absence comprises
receiving a user input from the user indicating a break or an absence from the environment;
determining that the user has turned off a camera capturing the live image of the user; and/or
using image recognition for determining that the user is absent or not recognizable in the live image,
wherein determining the return comprises
receiving a user input from the user indicating an end of a break or a return to the environment;
determining that the user has turned on the camera again; and/or
using image recognition for determining that the user is present and recognizable in the live image,
wherein no communication session with the client device associated with the absent user can be requested or opened during the user's absence.

6. The method according to claim 1, wherein displaying the live images comprises displaying image elements in a container of the graphical user interface, one live image being displayed within each of the image elements.

7. The method according to claim 6, wherein displaying the graphical indicator of an ongoing communication session comprises grouping the image elements displaying the live images of the users involved in the respective ongoing communication session.

8. The method according to claim 7, wherein grouping the image elements comprises merging or amalgamating the image elements into a joint element.

9. The method according to claim 7, wherein the graphical indicator comprises at least one of
a same colouring of a border of each of the grouped elements,
a ring-shaped or circular element encircling the grouped elements, and
lines connecting the grouped elements.

10. The method according to claim 6, wherein displaying the image elements comprises placing the image elements in the container using a physics simulation, the physics simulation comprising each image element being influenced by every other image element through a force, wherein the force
is attractive if the users of the respective live images are involved in an ongoing mutual communication session,
is repulsive if the users of the respective live images are not involved in an ongoing mutual communication session, and
varies in strength depending on a distance of the elements to each other.

11. The method according to claim 10, wherein
the force is the stronger, the closer the image elements are to each other, and
the physics simulation comprises the image elements colliding with each other and with a border of the container.

12. The method according to claim 10, wherein the physics simulation is performed locally on the client devices, so that every user has the image elements placed in the container individually.

13. The method according to claim 10, wherein the physics simulation recalculates the position of each image element, when
a user joins or leaves the virtual collaboration environment,
a communication session is opened or closed, and
a user joins or leaves a communication session,
wherein
the recalculation is iterated over a defined number of time steps and comprises calculating an influence of the summed force of all other image elements on each image element; and/or
an animation is performed in real time when the position of each image element position has been recalculated, the animation showing a movement of one or more image elements to their recalculated position.

14. The method according to claim 6, wherein a size of the image elements depends on
a size of the screen and/or of the container,
a number of image elements on the screen and/or in the container, and
a status of the user of the live image displayed within the respective image element, the status at least comprising being involved in an ongoing communication session or not,
wherein an image element and/or the live image displayed therein are enlarged, if the image element displays a live image of a user being involved in an ongoing communication session with the user of the client device on the display of which the graphical user interface is displayed.

15. The method according to claim 1, comprising the plurality of users joining the environment upon an invitation of an administrator of the environment.

16. The method according to claim 1, wherein each of the client devices comprises a user interface, a memory, a processor, a network interface, a camera, a speaker and a microphone, wherein
the user interface provides the graphical user interface and receives user inputs,
the camera captures the live image of the user, and
the speaker and the microphone are used in the communication session.

17. A computer-implemented method for providing a virtual collaboration environment for a plurality of users, each user being associated with one of a plurality of client devices that are connected via a data network, wherein each of the client devices comprises a user interface, a memory, a processor, a network interface, a camera, a speaker and a microphone, the method comprising
capturing live images of each of the plurality of users using the cameras;
visualizing a graphical user interface on a display of each of the client devices; and
displaying, within each graphical user interface, live images of at least a subset of the plurality of users;
providing, within each graphical user interface, an input option for requesting an audio communication with the other users of the subset;
receiving, on any one of the user interfaces, a first user input from a user of the subset requesting audio communication with another user of the subset;
starting, based on the first user input, a first communication session between a first client device associated with the requesting user and a second client device associated with the other user, wherein starting the first communication session comprises enabling mutual audio communication between the first client device and the second client device using the speakers and the microphones of the first client device and the second client device;
displaying, within each graphical user interface, a first graphical indicator of the ongoing first communication session and the users involved in the ongoing first communication session.

18. A system for providing a virtual collaboration environment for a plurality of users, the system comprising a plurality of client devices that are connected via a data network, each user being associated with one of the client devices, each of the client devices comprising a user interface, a memory, a processor, a network interface, a camera, a speaker and a microphone, a client communication application being stored in the memory and executable by the processor, the system being configured for performing the method according to claim 1.

19. The system according to claim 18, comprising a server computer that is connected with the client devices via the data network, the server computer comprising a server memory, a server processor and a server network interface, a communication manager application being stored in the server memory and executable by the server processor, the communication manager application being configured to serve requests from the client communication applications of the client devices.

20. A computer program product comprising programme code which is stored on a machine-readable medium, and having computer-executable instructions for performing the method according to claim 1.

21. A computer program product comprising programme code which is stored on a machine-readable medium, and having computer-executable instructions for performing the method according to 17.
